(19) United States
(12) Patent Application Publication
(10) Pub. No.: US 2026/0125094 A1
(43) Pub. Date: May 7, 2026

(54) DOLLY FOR VIYNL WRAPPING A VEHCILE

(71) Applicant: Ciejay Concepcion, Lake Bluff, IL (US)

(72) Inventor: Ciejay Concepcion, Lake Bluff, IL (US)

(21) Appl. No.: 18/940,323

(22) Filed: Nov. 7, 2024

(51) Int. Cl. B62B 3/10; B32B 38/18

(52) U.S. Cl. CPC B62B 3/104; B32B 38/18; B32B 2605/00

(57) ABSTRACT

A vinyl wrap dolly includes a rod having a first and second end. A first endcap coupled to the first end of the rod. A second endcap coupled to the second end of the rod. A base plate coupled to the second endcap. The rod is configured to hold a tube of vinyl wrap.

### CROSS REFERENCE TO RELATED APPLICATIONS

Not applicable

### REFERENCE REGARDING FEDERALLY SPONSORED RESEARCH OR DEVELOPMENT

Not applicable

### SEQUENCE LISTING

Not applicable

### BACKGROUND

### 1. Field of the Invention

The present disclosure relates generally to a dolly for vinyl wrapping.

### 2. Description of the Background

Vehicle vinyl wrap is the practice of completely or partially covering a vehicle's original paint with a vinyl wrap. There are various ways to cover the body of a vehicle with vinyl wrap. While some wrap installers have assistance in some fashion, some installers covering vehicles on their own without any additional mechanisms or assistive support to do so. The vinyl wrapping itself can be bulky and can come in a variety of sizes from 1 foot (ft.) by 5 ft. to 100 ft. by 5 ft. Because of the size of the vinyl wrap, applying a sheet of vinyl wrap to cover a vehicle can be challenging especially installing it alone. Improperly installing the vinyl wrap to a vehicle may result in tears in the vinyl, creasing, bubbling, and misalignment.

### SUMMARY

A dolly for vinyl wrapping, as described herein, may have various configurations.

In some embodiments, the present disclosure provides a vinyl wrap dolly includes a rod having a first and second end. A first endcap coupled to the first end of the rod. A second endcap coupled to the second end of the rod. A base plate coupled to the second end cap. The rod is configured to hold a tube of vinyl wrap.

In another embodiment, the present disclosure provides a dolly for vinyl wrapping that includes a rod having a first and second end; a first end cap coupled to the first end of the rod; a second end cap coupled to the second end of the rod; and a base plate coupled to the second end cap. The rod is configured to hold a tube of vinyl wrap. The base plate includes at least one wheel.

Other aspects of the systems and methods disclosed herein, including features and advantages thereof, will become apparent to one of ordinary skill in the art upon examination of the figures and detailed description herein. Therefore, all such aspects of the device are intended to be included in the detailed description and this summary.

### BRIEF DESCRIPTION OF THE DRAWINGS

FIG. 1 is a front perspective view of a dolly vinyl wrapping device having a base plate, according to an embodiment of the disclosure;

FIG. 2 is a side perspective view of the dolly vinyl wrapping device of FIG. 1;

FIG. 3 is a top perspective view of the base plate of FIG. 1;

FIG. 4 is another side perspective view of the base plate of FIG. 1;

FIG. 5 is a bottom perspective view of the base plate of FIG. 1;

FIG. 6 is a top view of another embodiment of a base plate in accordance with the present disclosure;

FIG. 7 is a front view of an alternate embodiment of a rod of the vinyl wrapping devices disclosed herein;

FIG. 8 is an alternate embodiment of an end cap of the vinyl wrapping devices disclosed herein; and

FIG. 9 is a flowchart illustrating a method of wrapping vinyl, as disclosed herein.

### DETAILED DESCRIPTION OF THE DRAWINGS

The following discussion and accompanying figures disclose various embodiments or configurations of a dolly for vinyl wrapping. Before any embodiments of the disclosure are explained in detail, it is to be understood that the embodiments disclosed herein are not limited in application to the details of construction and the arrangement of components set forth in the following description or illustrated in the following drawings. The embodiments disclosed herein are capable of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Given the benefit of this disclosure, skilled artisans will recognize the examples provided herein have many useful alternatives and fall within the scope of embodiments of the invention.

The term “about,” as used herein, refers to variation in the numerical quantity that may occur, for example, through typical measuring and manufacturing procedures used for dollies and other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about” and “approximately” refer to a range of values ±5% of the numeric value that the term precedes.

As used herein in the context of geometric descriptions, unless otherwise limited or defined, “substantially” indicates correspondence to a particular shape or dimension within conventional manufacturing tolerances for components of a similar type or that are formed using similar processes. In this regard, for example, “substantially round” can indicate a profile that deviates from a circle to within acceptable manufacturing tolerances. Further, as used herein, unless otherwise defined or limited, directional terms are used for convenience of reference for discussion of particular figures or examples. For example, references to “downward,” or other directions, or “lower” or other positions, may be used to discuss aspects of a particular example or figure, but do not necessarily require similar orientation or geometry in all installations or configurations. The present disclosure is directed to a system and method of wrapping vinyl.

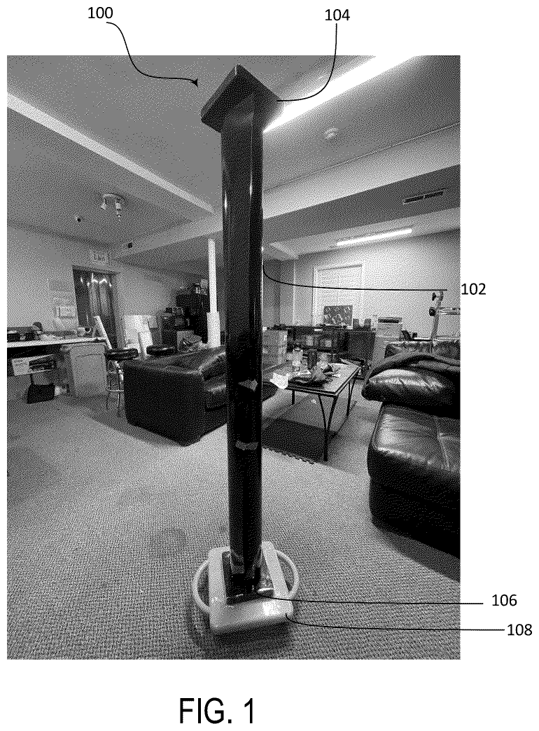

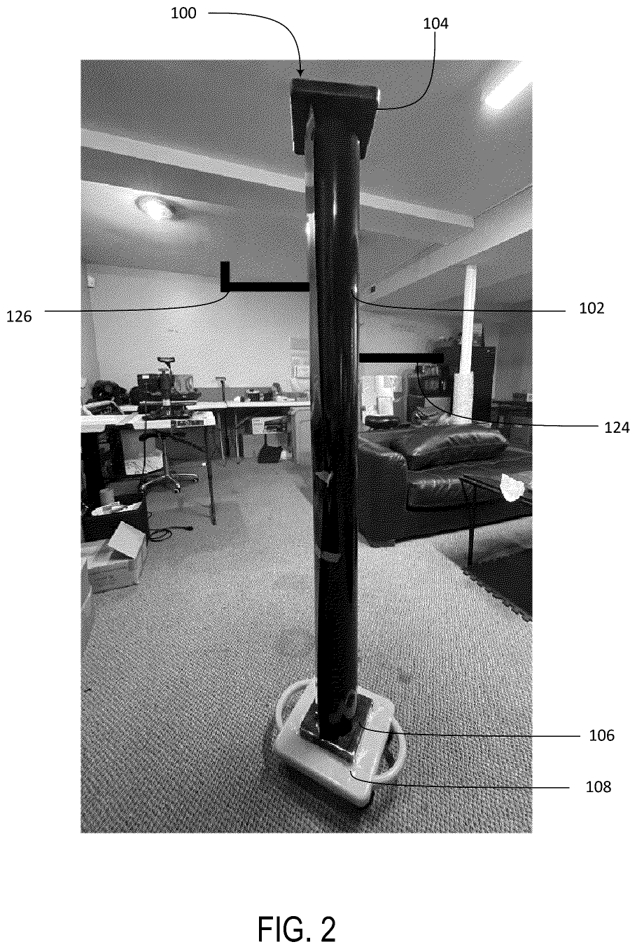

Referring now to the figures, and as shown in FIGS. 1 and 2, the vinyl wrap dolly 100 includes a rod 102 configured to hold a tube of vinyl wrap (not shown) or other material. The rod 102 is coupled to a first end cap 104 and a second end cap 106. The second end cap 106 is coupled to a base plate 108. The base plate 108 is configured to hold the first and second end caps 104 and 106 and the rod 102.

In some embodiments, the rod 102, the first end cap 104, the second end cap 106, and the base plate 108 may all be made of metal, such as stainless steel. However, in other applications, these components may be made of different materials. Furthermore, in some embodiments, the rod 102, the first end cap 104, the second end cap 106, and the base plate 108 may be made of plastic or another suitable material.

The rod 102 is substantially cylindrical in shape but other configurations are possible in order to accommodate the tube of vinyl wrap. The size of the rod 102 may vary depending on the tube of vinyl. In some embodiments, the rod 102 is adjustable, and may be made from plastic or metal. In some embodiments, the rod 102 comprises a single piece. In alternate embodiments, the rod comprises a first piece and a second piece that are joined together. Turning to FIG. 2, the rod 102 may further include at least one arm 124. The arm 124 may be fixedly attached to the rod 102 or removeable. In use, the arm 124 may further facilitate movement of the vinyl wrap dolly 100. The arm 124 may also be configured to hold items useful to installation such as scissors or tape. A second arm 126 may also be attached to the rod 102. However, in some applications, more or fewer arms may be attached to the rod 102.

In some embodiments, the first end cap 104 and second end cap 106 are fixed to the rod 102. The rod 102 may be attached to the first end cap 104 and the second end cap 106 with adhesive or another fastening means, such as a screw, nail, glue, Velcro, or tape. In alternate embodiments, the first end cap 104 and second end cap 106 are selectively removeable. In some embodiments, the first end cap 104 and second end cap 106 are interchangeable. In some embodiments, the first end cap 104 is configured to be received by a first end of the rod 102 and the second end cap 106 is configured to receive a second end of the rod 102.

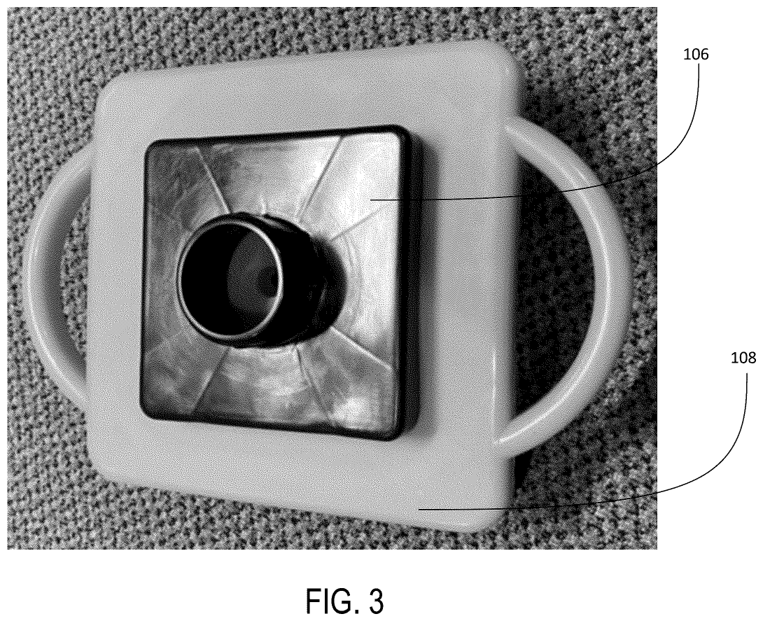

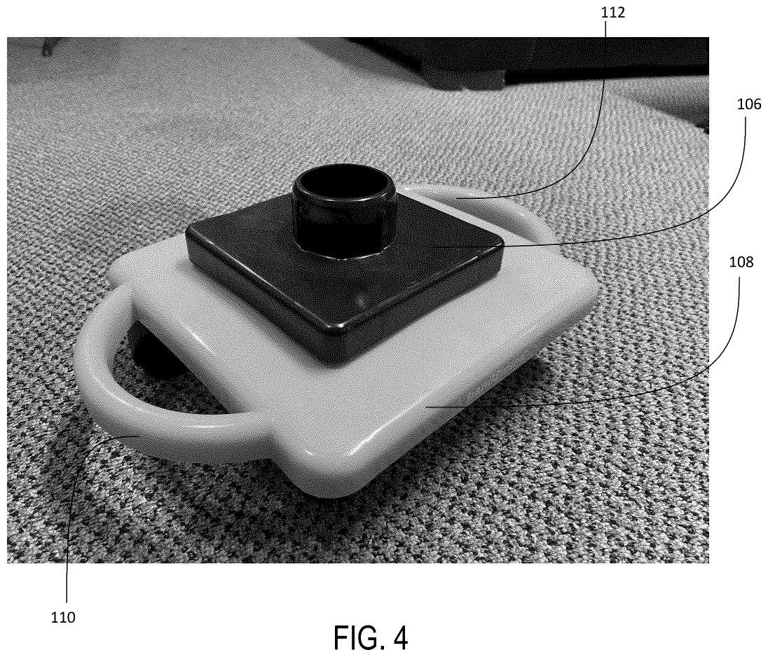

As shown in FIGS. 1-5, the base plate 108 may include a first handle 110 and a second handle 112. The first handle 110 and second handle 112 may be arched although other configurations are possible. In a use configuration, a user may put their hands or feet on the first and second handles 110, 112 to move the vinyl wrap dolly 100. Turning specifically to FIGS. 3 and 4, the second end cap 106 may include a through-hole 114 that is configured to receive the rod 102. The through-hole 114 of the second end cap 106 may be aligned at the center of the base plate 108. The base plate 108 and the second end cap 106 may be made from the same material. In alternate embodiments, the base plate 108 and the second end cap 106 may be made from different materials.

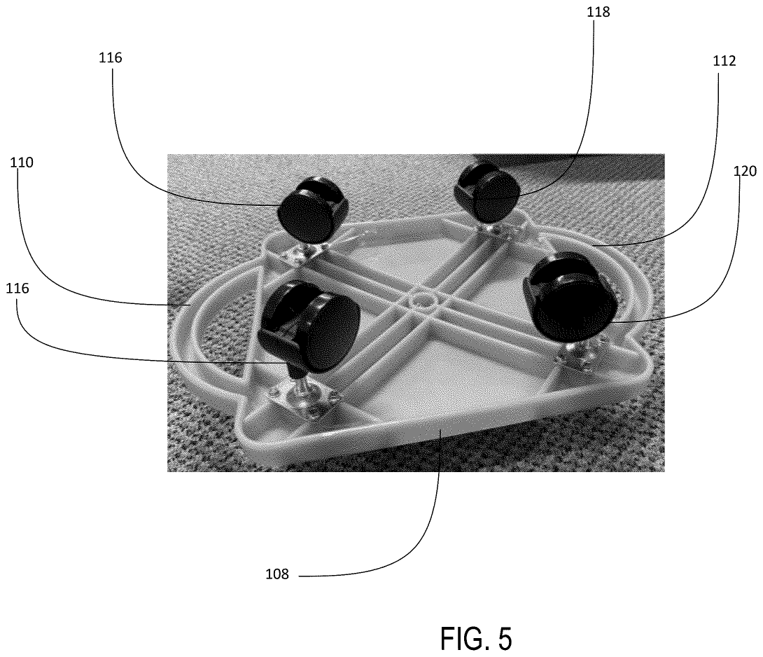

In a use configuration, the first handle 110 and the second handle 112 can be held by a user to move the vinyl wrap dolly 100 to its intended position. A user may also push the rod 102 in order to move the vinyl wrap dolly 100. The base plate 108 can include features to facilitate ease of movement. For example, as illustrated in FIG. 5, the base plate 108 can include at least one wheel 116 to allow the vinyl wrap dolly 100 to be rolled to a desired location. It may further include a first wheel 116, a second wheel 118, a third wheel 120, and a fourth wheel 122. The base plate 108 may include any number of wheels. The base plate 108 can also include a plurality of adjustable feet 124 (not shown). The plurality of adjustable feet 124 allow for the vinyl wrap dolly 100 to be locked in place.

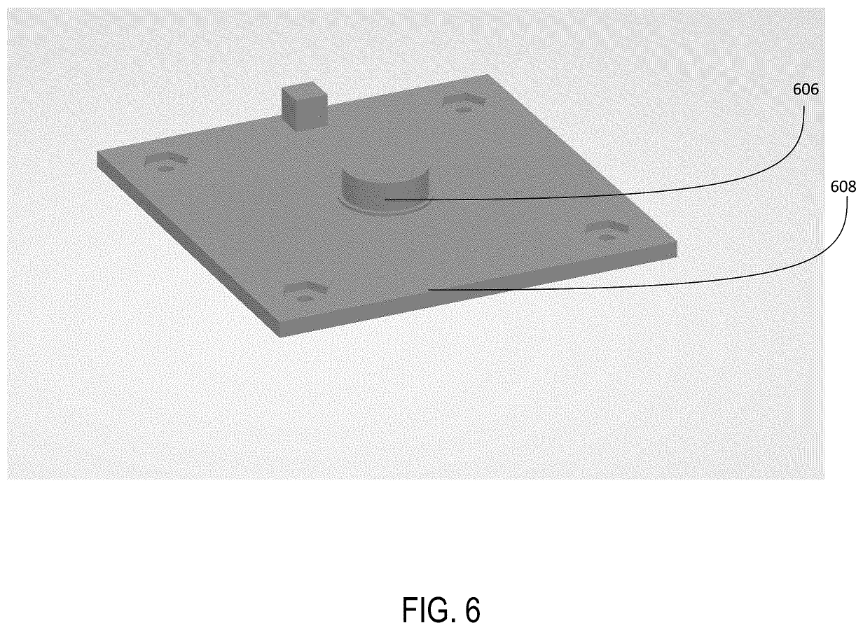

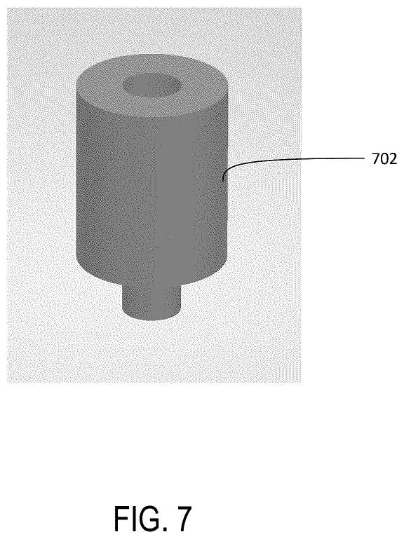

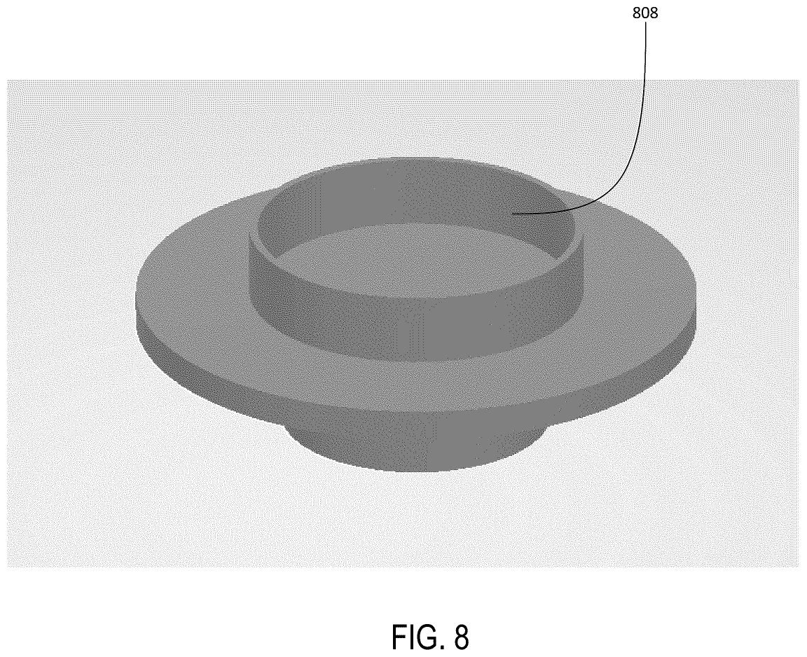

Turning now to FIG. 6, an alternate embodiment of the base plate 608 is shown. The base plate 608 may be configured to receive a first wheel 616, a second wheel 618, a third wheel 620, and a fourth wheel 622 (not shown) in the corners of the base plate 608. The base plate 608 may further include an end cap 606. The end cap 606 may be cylindrical in shape and configured to receive a rod 102, 702. Turning now to FIG. 7, an alternate embodiment of a rod 702 is shown. A first end of the rod 702 may be hollow to receive the end cap 606. Turning now to FIG. 8, an alternate embodiment of an end cap 808 is shown. The end cap 808 may include a cylindrical base that is configured to attach to a rod 102, 702 on one end and a base plate 108, 608 on the other.

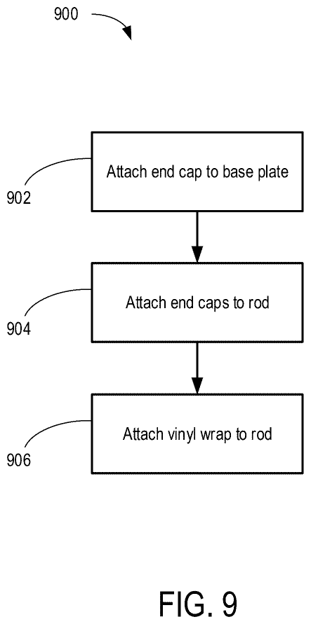

FIG. 9 illustrates in a flowchart 900 the steps taken to use the vinyl wrap dolly 100. The first step 902 includes attaching the second end cap 106 to a base plate 108. The next step 904 includes attaching the first end cap 104 and the second end cap 106 to the rod 102. The final step 906 includes attaching the vinyl wrap to the rod 102. Once on the rod 102, the user may roll out the vinyl wrap to a desired length and cut it. The user may then apply the vinyl wrap to the desired surface such as the exterior of a vehicle.

In other embodiments, other configurations are possible. For example, certain features and combinations of features that are presented with respect to particular embodiments in the discussion above can be utilized in other embodiments and in other combinations, as appropriate. Further, any of the embodiments described herein may be modified to include any of the structures or methodologies disclosed in connection with other embodiments. Additionally, the present disclosure is not limited to devices of the type specifically shown. Still further, aspects of the device of any of the embodiments disclosed herein may be modified to work with any type of wrapping.

As noted previously, it will be appreciated by those skilled in the art that while the embodiments above have been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the embodiments disclosed herein. The exclusive rights to all modifications which come within the scope of the appended claims are reserved.

We claim:

1. A vinyl wrap dolly comprising,
a rod having a first and second end;
a first endcap coupled to the first end of the rod;
a second endcap coupled to the second end of the rod; and
a base plate coupled to the second endcap
wherein the rod is configured to hold a tube of vinyl wrap.

2. The vinyl wrap dolly of claim 1, wherein the base plate is operably coupled to at least one wheel.

3. The vinyl wrap dolly of claim 1, wherein the rod, first end cap, second end cap and base plate are positioned along a central axis.

4. The vinyl wrap dolly of claim 1, wherein the rod includes at least one arm.

5. The vinyl wrap dolly of claim 4, wherein the at least one arm is disposed at a first point between the first endcap and the second endcap.

6. The vinyl wrap dolly of claim 4, wherein the at least one arm includes a first arm and a second arm.

7. The vinyl wrap dolly of claim 4, wherein the arm is configured to hold additional objects.

8. The vinyl wrap dolly of claim 1, wherein the rod is configured to hold a tube of vinyl wrap.

9. The vinyl wrap dolly of claim 8, wherein the rod is configured to hold vinyl wrap in a horizontal orientation.

10. The vinyl wrap dolly of claim 1, wherein the base plate further comprises at least one handle.

11. A dolly for vinyl wrapping comprising:
a rod having a first and second end;
a first end cap coupled to the first end of the rod;
a second end cap coupled to the second end of the rod; and
a base plate coupled to the second end cap,
wherein the rod is configured to hold a tube of vinyl wrap, and
wherein the base plate includes at least one wheel.

12. The dolly for vinyl wrapping of claim 11, wherein the rod is cylindrical.

13. The dolly for vinyl wrapping of claim 11, wherein the rod includes at least one arm extending therefrom.

14. The dolly for vinyl wrapping of claim 13, wherein the at least one arm is midway between the first end cap and the second end cap.

15. The dolly for vinyl wrapping of claim 13, wherein the at least one arm is configured to hold additional objects.

16. The dolly for vinyl wrapping of claim 13, wherein the at least one arm includes a first arm and a second arm.

17. The dolly for vinyl wrapping of claim 11, wherein the rod is hollow.

18. The dolly for vinyl wrapping of claim 11, wherein the rod is configured to hold vinyl wrap in a horizontal orientation.

19. The dolly for vinyl wrapping of claim 11, wherein the rod is configured to hold a tube of vinyl wrap.

20. The dolly for vinyl wrapping of claim 11, wherein the base plate further comprises at least one handle.
